(19) United States
(12) Patent Application Publication
(10) Pub. No.: US 2025/0307781 A1
(43) Pub. Date: Oct. 2, 2025

(54) Automation-Sequence Initiator Engine

(71) Applicant: Sage Software, Inc., Richmond, VA (US)

(72) Inventors: Peter H. Horadan, Kirkland, WA (US); Matthew R. Shanahan, Seattle, WA (US)

(21) Appl. No.: 18/865,560

(22) PCT Filed: May 16, 2023
(86) PCT No.: PCT/US2023/022356

§ 371 Date: Nov. 13, 2024

Related U.S. Application Data
(60) Provisional application No. 63/342,996, filed on May 17, 2022.

(51) Int. Cl. G06Q 10/107; H04L 51/234

(52) U.S. Cl. CPC G06Q 10/107; H04L 51/234

(57) ABSTRACT

A method of initiating an automation sequence. The method includes, at a computing system on which is running an automation-sequence initiator engine, downloading and storing on data storage ERP object data from an ERP system associated with a first organisational entity. An electronic message is retrieved from a messaging client sent to the first organisational entity. The electronic message is analysed to identify entity-signifying metadata in the message. The ERP object data is queried in the data storage with the entity-signifying metadata to identify a further organisational entity. If a further organisational entity is identified, relationship data is identified associated with the further organisational entity. An automation sequence is selected based on the relationship data. The automation sequence is initiated, and the electronic message is processed in accordance with the initiated automation sequence.

### TECHNICAL FIELD

The present technology relates to techniques for initiating automation sequences in response to receiving electronic messages such as, but not limited to, e-mail.

### BACKGROUND

Enterprise Resource Planning (ERP) systems are extensively employed to manage and streamline various business processes, offering robust data collection, analysis, and processing capabilities. However, a significant challenge arises from the manual handling of e-mails associated with these systems. These e-mails, often tied to tasks such as order confirmations, invoice processing, or communication with suppliers and customers, play a crucial role in updating data and initiating various accounting processes linked to ERP systems. Nevertheless, they are frequently received across multiple user inboxes, like Gmail or Outlook, which are detached from the ERP systems themselves.

This disconnection complicates the management of communication, tasks, and workflows, as users are typically required to switch between different platforms constantly. The separation between e-mail clients and ERP systems also hinders the automation of tasks, further exacerbating inefficiencies within these systems.

Moreover, this lack of integration presents additional challenges, such as difficulties in tracking workflows, the need for manual e-mail allocation to tasks, time-consuming document sorting, increased risk of errors, and obstacles in team collaboration.

While directly integrating existing e-mail client functionalities, such as those found in Gmail or Outlook, into ERP systems might address these issues, several drawbacks exist. These include the complex and time-consuming nature of the integration process, the necessity for significant software modifications, and the challenge of accommodating the wide range of e-mail and ERP platforms available in the market.

### SUMMARY

In accordance with a first aspect of the invention there is provided a method of initiating an automation sequence. The method comprises: at a computing system on which is running an automation-sequence initiator engine: downloading and storing on data storage ERP object data from an ERP system associated with a first organisational entity; retrieving from a messaging client an electronic message sent to the first organisational entity; analysing the electronic message to identify entity-signifying metadata in the message; querying the ERP object data in the data storage with the entity-signifying metadata to identify a further organisational entity, wherein, if a further organisational entity is identified, identifying relationship data associated with the further organisational entity; selecting an automation sequence based on the relationship data; initiating the automation sequence, and processing the electronic message in accordance with the initiated automation sequence.

Optionally, if a further organisational entity is identified, the method further comprises: generating a mapping between an address from which the electronic message was sent and the identified further organisational entity, and storing the mapping to mapping storage.

Optionally, the method further comprises, on retrieving the electronic message, identifying an address from which the electronic message was sent; querying the mapping storage to identify if a pre-existing mapping exists between the address from which the electronic message was sent and a pre-identified organisational entity, and if so: identifying relationship data associated with the pre-identified organisational entity; selecting an automation sequence based on the relationship data; initiating the automation sequence, and processing the electronic message in accordance with the initiated automation sequence.

Optionally, the method further comprises identifying process context data from the electronic message, and selecting an automation sequence based on the relationship data and the process context data.

Optionally, identifying the process context data from the electronic message comprises at least one of: processing the data content of the electronic message in accordance with a predetermined rule-based schema, and processing the data content of the electronic message using an AI-analysis function.

Optionally, the method further comprises adaptively processing the electronic message in accordance with the initiated automation sequence and the process context data.

Optionally, the method further comprises identifying one or more ERP objects from the ERP object data associated with the initiated automation sequence, and adaptively processing the electronic message in accordance with the initiated automation sequence and the one or more ERP objects.

Optionally, the entity-signifying metadata is a first type of entity-signifying metadata.

Optionally, if on querying the data storage with the first type of entity-signifying metadata a further organisational entity is not identified, the method further comprises: analysing the electronic message to identify a second type of entity-signifying metadata in the message, and querying the data storage with the second type of entity-signifying metadata to identify the further organisational entity.

Optionally, the first type of entity-signifying metadata comprises an originating domain from which the electronic message was sent, and the second type of entity-signifying metadata comprises message header data indicative of a contact address from whom the electronic message was sent.

Optionally, if on querying the data storage with the first type of entity-signifying metadata a further organisational entity is not identified, the method further comprises: analysing the content of the electronic message to identify further entity-signifying content data, and querying the data storage with the further entity-signifying content data to identify the further organisational entity.

Optionally, identifying the further entity-signifying content data from the electronic message comprises at least one of: processing the data content of the electronic message in accordance with a predetermined rule-based schema, and processing the data content of the electronic message using an AI-analysis function.

Optionally, the initiated automation sequence implements one of a plurality of predefined business management processes.

Optionally, processing the electronic message in accordance with the initiated automation sequence comprises presenting data relating to the automation sequence to a user via a user interface.

Optionally, the electronic message is an e-mail message and the messaging client is an e-mail client.

In accordance with a second aspect of the invention there is provided a system for initiating automation sequences. The system comprises: a computing system comprising data storage and on which is running an automation-sequence initiator engine; a messaging client; and a computer-implemented ERP system associated with a first organisational entity. The computing system is communicatively connected to the ERP system and the messaging client. The automation-sequence initiator engine is configured to: download ERP object data from the ERP system and store the ERP object data on the data storage: retrieve from the messaging client an electronic message sent to the first organisational entity; analyse the electronic message to identify entity-signifying metadata in the message; query the ERP object data in the data storage with the entity-signifying metadata to identify a further organisational entity, wherein, if a further organisational entity is identified, the automation-sequence initiator engine is further configured to: identify relationship data associated with the further organisational entity; select an automation sequence based on the relationship data; initiate the automation sequence, and process the electronic message in accordance with the initiated automation sequence.

In accordance with a third aspect of the invention there is provided an automation-sequence initiator engine for use in a system according to the second aspect. The automation-sequence initiator engine is configured to: download and store on data storage ERP object data from an ERP system associated with a first organisational entity; retrieve from a messaging client an electronic message sent to the first organisational entity; analyse the electronic message to identify entity-signifying metadata in the message; query the ERP object data in the data storage with the entity-signifying metadata to identify a further organisational entity, wherein, if a further organisational entity is identified, the automation-sequence initiator engine is further configured to: identify relationship data associated with the further organisational entity; select an automation sequence based on the relationship data; initiate the automation sequence, and process the electronic message in accordance with the initiated automation sequence.

In accordance with a fourth aspect of the invention there is provided a computer program which when run on a suitable computing device implements an automation-sequence initiator engine according to the third aspect.

In accordance with a fifth aspect of the invention there is provided an automated facility for executing inter-entity accounting transactions, comprising: receiving an electronically-transmitted message at an automated destination address, the electronically-transmitted message comprising a transaction identifier; searching a database of uncompleted transactions for the transaction identifier to locate an uncompleted transaction record; if the uncompleted transaction record is found, then augmenting the uncompleted transaction record with additional information extracted automatically from the electronically transmitted message to produce an augmented transaction record; recording the augmented transaction record in the database; and if the augmented transaction record comprises a predetermined set of information elements, marking the augmented transaction record as a completed transaction record.

In accordance with embodiments of the invention, it has been observed that while the performance of many accounting and business process tasks such as accounts receivable (AR) and accounts payable (AP) tasks are centred around the sending and receiving of e-mails, conventional ERP systems that manage AR and AP data often lack e-mail integration. Consequently, users who manage these tasks typically have to manually switch between several different systems to oversee and manage these tasks, namely an e-mail system for sending and receiving e-mails, a task tracking system for allocating tasks and managing work flows, and an ERP system into which data is entered and from which data is extracted.

In accordance with embodiments of the invention it has been recognised that the inefficiencies that arise from this can be addressed with minimal technical adaptation by the provision of a technique in which a new system (an e-mail-driven automation-sequence initiator engine) is introduced which retrieves relevant e-mails relating to AR and AP tasks from an e-mail client, maintains a local storage of ERP object data downloaded from an ERP system and provides a centralised and single point from which AR and AP tasks can be performed.

Advantageously, the fact that such a system has access to both relevant e-mails and the ERP object data means that automation sequences associated with workflow steps of AR and AP processes can be initiated and automatically run based on the receipt and analysis of relevant e-mails received by the e-mail client. This means that not only are these tasks run from a single point, but the architecture that underpins the system inherently enables useful automation to be performed.

Moreover, in typical embodiments, to implement the e-mail-driven automation-sequence initiator, no fundamental adaptations to existing e-mail clients or ERP systems are required, beyond the provision of suitable APIs or the provision of a suitable e-mail-client plugin.

Furthermore, the e-mail-driven automation-sequence initiator engine enables multiple users to easily access a centralised interface. This single point allows users to share, perform, and track accounting and business process tasks, such as managing accounts receivable (AR) and accounts payable (AP), whilst maintaining a clear audit trail of performed actions. This solution stands in contrast to a common conventional approach, where multiple users are given access to the same e-mail inbox.

Not only is the conventional shared inbox approach difficult to scale and administrate in terms of security and permissions, but it also suffers from inherent limitations. Many e-mail systems have latency issues that can cause conflicts due to the lack of real-time synchronisation between users' individual views and actions. Moreover, shared e-mail inboxes typically lack a facility to maintain an audit trail of actions taken by each user, which is typically important for transparency and accountability

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram depicting a system configured to implement an e-mail-driven automation-sequence initiator engine in accordance with certain embodiments of the invention;

FIG. 2 provides a diagram depicting a process performed by the system depicted in FIG. 1 in accordance with certain embodiments of the invention;

FIG. 3 provides a diagram depicting the steps of the organisational entity identification process performed by an entity mapper in accordance with certain embodiments of the invention;

FIG. 4 provides a diagram depicting a process for executing inter-entity accounting transactions in accordance with certain examples, and

FIG. 5 provides a schematic diagram of a system for implementing an automated facility for executing inter-entity accounting transactions of a type described with reference to FIG. 4.

### DETAILED DESCRIPTION

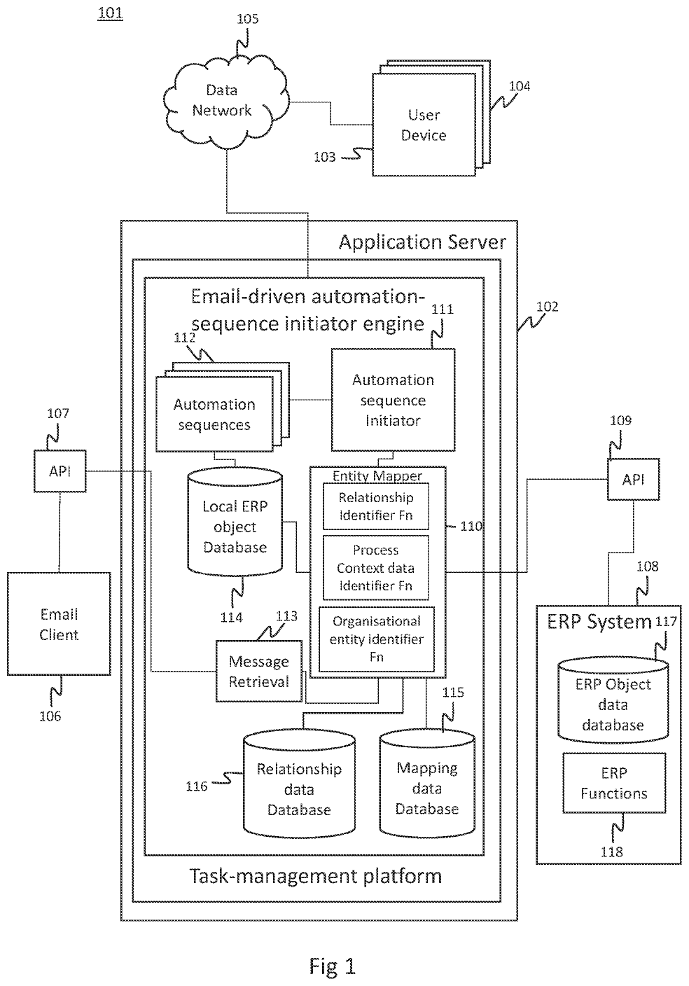

FIG. 1 provides a simplified schematic diagram depicting a system 101 comprising an application server 102 on which is running an e-mail-driven automation-sequence initiator engine. The e-mail-driven automation-sequence initiator engine is configured to adaptively initiate and execute automation sequences based on e-mails received at an e-mail client.

In typical examples the e-mail-driven automation-sequence initiator engine running on the application server 102 is part of an online task-management platform running on the application server 102 which provides a graphical interface (showing workflows, dashboards, document management systems and so on) and a data management system enabling one or more users to manage and execute workflows associated with accounting process, such as accounts receivable (AR) processes and accounts payable (AP) processes, where those processes are centred around sending e-mails to, and receiving e-mails from, third party organisational entities, such as vendors and customers.

Typically, the task management platform, the user device 103, plurality of user devices 104 and ERP system 108 are associated with a first organisational entity, for example a specific company or organisation. The user device 103 may typically be a computing device, such as a personal computer or similar computing terminal associated with an operative of the organisational entity and similarly the plurality of user devices 104 are each computing devices associated with other operatives of the organisational entity.

The e-mail-driven automation-sequence initiator engine is configured to selectively initiate specific automation sequences in response to the processing of e-mails received at an e-mail client. These automation sequences typically comprise the automated execution of workflow steps related to accounts-receivable (AR) and accounts-payable (AP) processes such as processes relating to the receipt e-mails pertaining to: invoices, payment remittances, statements of account, shipment advice, receipt of goods advice, credit memos, disputes, account balances, quotes, orders, contact information, customer onboarding, payment terms, payment methods, tax information and any other suitable accounting related transaction.

The automated workflow steps may include steps associated with processing, categorisation, and docketing of received documents and files; generating e-mail responses; assigning tasks to specific users to update ERP system AR and AP records, and so on. The automated workflow steps may also include steps associated with generating and display user interfaces including workflow interfaces, task allocation interfaces, data dashboards, file management interfaces and so on.

The system comprises an application server 102 on which is running an e-mail-driven automation-sequence initiator engine which is communicatively connected to a user device 103, which is one of a plurality of user devices 104 to which the application server 102 is connected, via a data network 105.

In a typical embodiment, the user device 103 and each of the user devices of the plurality of user devices 104 each have running thereon web browsing software via which an interface is provided by the application server 102 which enables the user device 103 to access the e-mail-driven automation-sequence initiator engine.

The application server 102 is further connected to an e-mail client 106 via a first API 107 and connected to an ERP system 108 via a second API 109. The first API 107 and second API 109 can be implemented in any suitable way. For example, they can be based on well-known web service protocols such as REST (Representational State Transfer), SOAP (Simple Object Access Protocol), or GraphQL. These APIs can support data interchange formats like JSON (JavaScript Object Notation), XML (Extensible Markup Language), or Protocol Buffers.

To implement the e-mail-driven automation-sequence initiator engine, the application server 102 has running thereon software providing an entity mapper 110, an automation sequence initiator 111, functions defining a plurality of automation sequences 112, and a message retrieval function 113.

The application server 102 further incorporates data storage including a local ERP object data database 114, a mapping data database 115 and a relationship database 116. The ERP system 108 further comprises an ERP object data database 117 and functionality for implementing various ERP functions 118.

The local ERP object data database 114 and mapping data database 115 can be implemented in any suitable way, as is well known in the art. For example, they can be based on relational database management systems (RDBMS) such as MySQL, PostgreSQL, Oracle, or Microsoft SQL Server, or NoSQL databases like MongoDB, Cassandra, or Couchbase. Additionally, they may be deployed on-premises, in the cloud, or using a hybrid approach, depending on the requirements and preferences for data storage, accessibility, security, and performance.

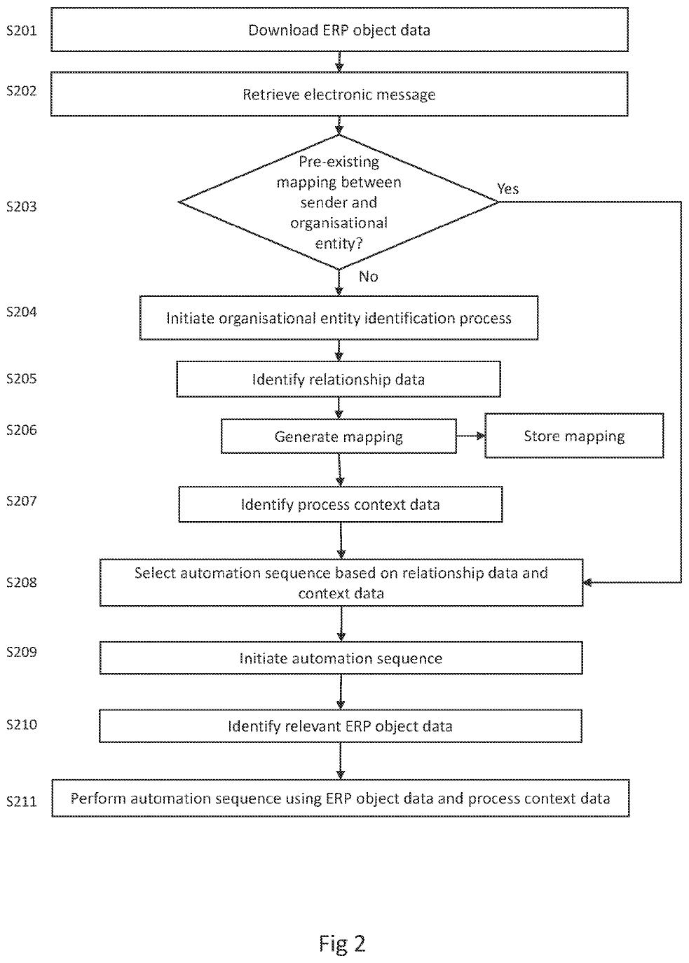

As the skilled person will understand, although depicted as a single entity in FIG. 2, the application server 102 can be implemented in any suitable way. For example, in certain embodiments, the application server 102 can be provided by a dedicated physical server or a cluster of servers. Alternatively, the application server 102 can be implemented within a virtualized environment, where multiple virtual machines (VMs) or containers are hosted on a single physical server or cluster. Further still, the application server 102 can be implemented on a cloud-based infrastructure, such as Amazon Web Services (AWS), Microsoft Azure, or Google Cloud Platform. In certain embodiments, a hybrid configuration may be used, combining on-premises physical or virtualized servers with cloud-based resources. Alternatively, the application server 102 could be implemented in an edge computing environment, where processing and storage resources are distributed closer to the end-users or data sources.

As the skilled person will understand, the implementation of the entity mapper 110, automation sequence initiator 111, automation sequence functions 112, and message retrieval function 113, along with other components of the e-mail-driven automation-sequence initiator engine can be implemented in any suitable way. For example, they can be developed using various programming languages such as C++, Java, Python, or JavaScript. In typical embodiments, the implementation of these components may depend on the chosen implementation method for the application server 102. For example, when deploying the components on a cloud-based infrastructure, they can be developed using programming languages and architectural frameworks that are well-suited for cloud environments, such as Python, Java, or JavaScript, and using microservices or serverless architectures. Similarly, when the application server 102 is implemented in a virtualized or edge computing environment, the components can be developed and deployed with consideration for the specific requirements and constraints of these environments, such as resource allocation, network latency, and data processing. The selection of the most suitable implementation approach for the components will be influenced by factors such as scalability, security, performance, and maintainability requirements of the system, as well as the chosen implementation method for the application server 102 itself.

Operation of the system 101 will now be described further with reference to FIG. 2.

FIG. 2 provides a diagram depicting a process performed by the system 101 to initiate an automation sequence in response to the retrieval of an e-mail.

At the initial stage S201, ERP object data from the ERP object data database 116 is downloaded from the ERP system 108 by the application server 102 and stored in the mapping data database 115. The first step S201 is generally performed periodically and is not synchronised with the e-mail retrieval of the second step S202, which is described below. This ERP object data typically consists of various ERP objects such as: contact objects that represent external organisations or individuals the organisational entity interacts with, including their names, roles, contact details, business identification numbers, preferred communication methods, and historical transaction records; product objects that store details about products or services offered by the organisational entity, including product identifiers, descriptions, pricing information, inventory levels, and associated documentation; financial objects that capture financial data related to the organisational entity, useful for accounting and reporting purposes, such as general ledger accounts, balance sheets, income statements, and tax information; invoice and remittance document objects which store information regarding issued invoices, received payments, and related transaction documents, including invoice numbers, payment references, dates, amounts, currency, payment terms, and payment status. These objects facilitate the tracking and reconciliation of financial transactions between the organisational entity and its external contacts.

At a second step S202, the message retrieval function 113 is configured to send a message retrieval request to the first API 107 querying whether the e-mail client 106 has received a relevant e-mail. If the e-mail client 106 has received such an e-mail, it is forwarded from the e-mail client 106 to the message retrieval function 113 via the first API 107.

A relevant e-mail is typically an e-mail that is sent to a specific accounting-related e-mail address (e.g. accounts@company.com) designated for receiving AP or AR, or other accounting or business process-related communications. Additionally, an e-mail can also be identified as relevant based on the content of its e-mail header, subject header, or other similar metadata that may indicate its association with accounting-related processing.

The message retrieval function 113 is then configured to forward the e-mail to the entity mapper 110. At a third step S203, the entity mapper 110 then analyses the e-mail to determine an address from which it was sent and query the mapping data database 115 to determine whether or not there is a pre-existing mapping between the address and an organisational entity.

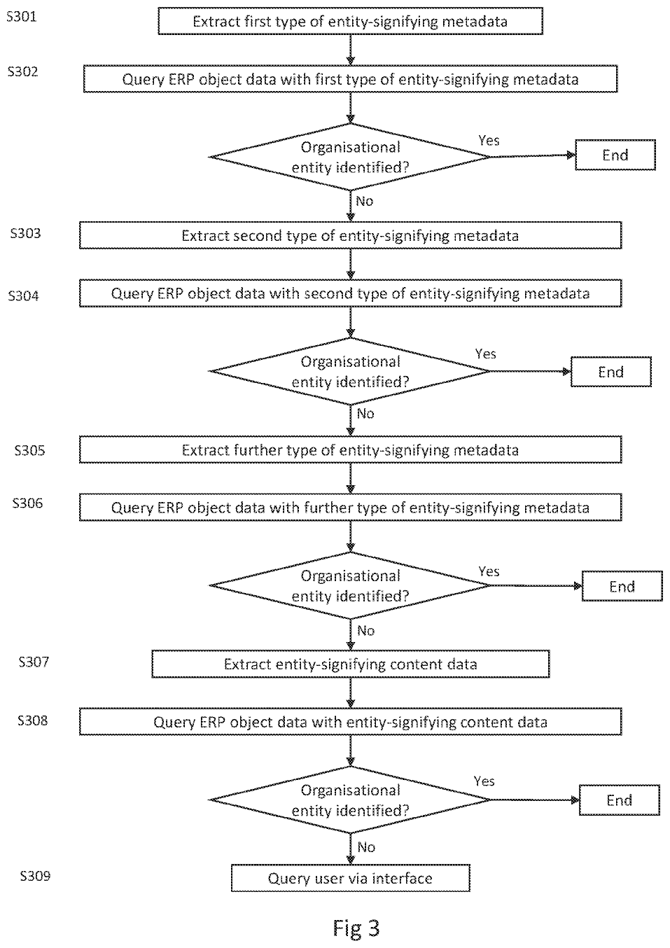

If at the third step S203, the entity mapper 110 determines that that is no pre-existing mapping, at a fourth step, the entity mapper 110 initiates and performs an organisational entity identification process. This process is explained further with reference to FIG. 3.

Returning to FIG. 2, once the organisational entity identification process has identified an organisational entity associated with the address from which the retrieved e-mail was sent, at a fifth step S205, relationship data associated with a relationship connecting the identified organisation entity and the organisational entity associated with the user device 103 is determined.

In some examples, the relationship data is obtained from the relationship database 116.

The process of deriving relationship data can be accomplished through various means. In some instances, the data may be obtained from the ERP object data database 117 and stored in the relationship database 116.

Alternatively, the relationship data can be ascertained directly from the content of the retrieved e-mail itself. For example, a relationship identifier function of the entity mapper 110 may analyse the sending and receiving e-mail addresses to establish the business relationship associated with the e-mail. Different e-mail addresses may be used by the same party when interacting with the receiving party, depending on whether the communication pertains to a customer or vendor interaction. In certain situations, both parties may act alternately as vendor and customer with respect to each other, based on the specific context of their interactions. By examining the unique combinations of sending and receiving e-mail addresses, the entity mapper 110 can identify the relevant business relationship and manage the corresponding processes accordingly.

At a sixth step S206, the entity mapper 110 generates a mapping between the identified organisational entity and the organisational entity associated with the user device 103 and stores this mapping in the mapping data database 115. Typically, this mapping is stored with the relationship data identified at the fifth step S205.

At the seventh step S207, the entity mapper 110 is designed to analyse the content of the retrieved e-mail to identify process context data from the e-mail. Process context data is any type of data derived from the e-mail that can help indicate the type of process the e-mail pertains to. This data may include, but is not limited to, message content, header information, subject line data, or other relevant elements within the e-mail.

For instance, process context data can provide insights into whether the e-mail relates to an accounts receivable communication, such as a client remittance notification, or an accounts payable interaction, like a vendor invoice request.

For example, the entity mapper 110 may include a process context data identifier function configured to identify the process context data from the received e-mail using any suitable technique. Such techniques include keyword identification, involving searching for specific keywords, phrases, or patterns within the e-mail content, subject line, or header information that indicate the type of process the e-mail is related to; natural language processing (NLP), which using NLP algorithms to analyse the e-mail text in order to determine context and classify the e-mail based on the relevant business process; machine learning (AI) models, using models on historical e-mail data, enabling the identification of process context data by recognising patterns or features that are common to specific processes and large language models (LLM), where the e-mail is passed through an LLM, such as GPT4; rule-based systems, which involve using a set of predefined rules to classify e-mails based on the presence of specific words, phrases, or patterns in the e-mail content, subject, or header information, or hybrid approaches, that combine multiple methods like keyword identification with machine learning models or NLP to augment the accuracy and efficiency of process context data identification in e-mails.

The entity mapper 110 then forwards the relationship data identified at the fifth step S205 on the process context data identified at the seventh step S207, to the automation sequence initiator automation sequence initiator 111.

At an eighth step S208, the automation sequence initiator 111 is configured to select an automation sequence from the plurality of automation sequences 112 based on the relationship data and the process context data.

At the ninth step S209, the automation sequence initiator automation sequence initiator 111 is configured to initiate the selected automation sequence.

In some examples, additional ERP object data may be required to implement the process.

If the automation sequence requires any ERP object data, at a tenth step S210 this ERP object data is retrieved from the local ERP object data database 114. At an eleventh step S211, the selected automation sequence is executed using any ERP object data retrieved at the tenth step S210 and any relevant process context data extracted at the seventh step S207.

As mentioned above, at the fourth step S204 the entity mapper 110 is configured to perform an organisational entity identification process.

This process is described further with reference to FIG. 3. FIG. 3 provides diagram depicting the steps of the organisational entity identification process performed by the automation sequence initiator entity mapper 110.

At a first step S301, an organisational entity identifier function of the entity mapper 110 extracts from the retrieved e-mail a first type of entity-signifying metadata. In certain examples, this first type of entity-signifying metadata is the domain of the address from which the retrieved e-mail was sent. For example, if the e-mail was received from johnsmith@acmeparts.com, this would be “acmeparts.com”.

At a second step S302, the entity mapper 110 generates a query with this entity-signifying metadata and queries the local ERP object data database 114 to determine if this entity-signifying metadata corresponds to an ERP contact object indicative of a particular organisational entity.

If this is the case, for example the local ERP object data database 114 may comprises contact object data linking the domain “acmeparts.com” with the organisational entity “Acme Parts Limited”. Data identifying this organisational entity is then output by the process.

However, if this query does not result in an organisational entity being identified, at a third step S303 the entity mapper 110 extracts a second type of entity-signifying metadata from the retrieved e-mail. In certain examples, this may be a contact name which is embedded in the e-mail header, for example the contact name “John Smith”. This is data which is often displayed by an interface of an e-mail client alongside the sender's e-mail address, typically within angled brackets or parentheses, such as <John Smith>john.smith@gmail.com.

At a fourth step S304, the entity mapper 110 generates a query with this entity-signifying metadata and queries the local ERP object data database 114 to determine if this second type of entity-signifying metadata corresponds to an ERP contact object indicative of a particular organisational entity.

If this is the case, for example if the local ERP object data database 114 may comprises contact object data linking the contact name “John Smith” with the organisational entity “Acme Parts Limited”, data identifying this organisational entity is then output by the process.

However, if this query does not result in an organisational entity being identified, at a fifth step S305, the entity mapper 110 extracts a further type of entity-signifying metadata from the retrieved e-mail. In certain examples, this may be further information present in the header of the retrieved e-mail.

For example, the retrieved e-mail may be sent on behalf of the organisational entity associated with the user device 103 by a third-party entity, for example third party entity which handles invoicing operations for the organisational entity associated with the user device 103. In such an example, the e-mail may be sent from a generic e-mail address such as “invoices@invoicemanager.com” with a generic contact name such as “<invoice manager>”. However, the header data of the e-mail may contain “non-visible” data added by the third party entity which isn't typically visible on an e-mail client but which nonetheless identifies the organisational entity associated with the user device 103. This “non-visible” data may include plain text which identifies the organisational entity associated with the user device 103 (for example plaintext specifying “Acme Parts Limited”) or some other form of data which identifies the organisational entity for example an account number or account code.

At a sixth step S306, the entity mapper 110 generates a query with this further entity-signifying metadata and queries the local ERP object data database 114 to determine if this further type of entity-signifying metadata corresponds to an ERP contact object indicative of a particular organisational entity.

If this is the case, for example if the local ERP object data database 114 comprises contact object data linking an account code “123ABC” found in the header of the retrieved e-mail with the organisational entity “Acme Parts Limited”, data identifying this organisational entity is then output by the process.

This process can be performed repeatedly until there are no further types of entity-signifying metadata left to try.

If these queries using the further types of entity-signifying metadata do not result in an organisational entity being identified, at a seventh step S307, the entity mapper 110 analyses the content of the retrieved e-mail to identify potentially entity-signifying content data from the e-mail.

Entity-signifying content data is typically data found within the content of the e-mail, such as e-mail text, that may provide indications of the identity of the organisational entity associated with the sender of the e-mail. This type of data can encompass various forms of contact information, such as references to names, phrases, or other details linked to a particular organisational entity.

The identification of entity-signifying content data can be achieved using techniques similar to those previously mentioned for the identification of process context data. These techniques allow the system to effectively recognise and associate e-mail senders with their respective organisational entities. Such methods include keyword identification, Natural Language Processing (NLP), machine learning models, Large Language Models (LLM), rule-based systems, and hybrid approaches that combine multiple methods.

At an eighth step S308, the entity mapper 110 generates a query with this entity-signifying content data and queries the local ERP object data database 114 to determine if this entity-signifying content data corresponds to an ERP contact object indicative of a particular organisational entity.

If this is the case, data identifying this organisational entity is then output by the process. However, if the organisational entity associated with the retrieved e-mail is not identified, as a final resort, a user of the user device 103 can be queried to provide information identifying the organisational entity associated with the retrieved e-mail.

A first illustrative example of the operation of the e-mail-driven automation-sequence initiator engine is now provided. In this example, an e-mail is received from a vendor including an invoice document and the automated sequence which is initiated relates to the automatic execution of workflow steps relating to storing the e-mail in a correct folder, that is a folder associated with the vendor. However, in this example, the e-mail address from which the e-mail is sent has not previously been mapped to the vendor.

With reference to FIGS. 1 and 2, at a first step S201, the message retrieval function 113 retrieves the e-mail from the e-mail client 106 via the first API 107. At the second step S202, the entity mapper 110 determines whether or not there is a pre-existing mapping between the sender of the e-mail and an organisational entity. In this case it is determined that such a mapping does not exist, therefore at a fourth step S204, the entity mapper 110 initiates the organisational entity identification process. This results in the vendor organisational entity being identified (because, for example, the domain from which the e-mail was sent was associated in the local ERP object data database 114 with the vendor organisation entity), and at the fifth step S205, the relevant relationship data is retrieved from the relationship database 116 which indicates that the vendor organisational entity is associated with a “vendor” type relationship. At a sixth step S206, a mapping is made between the e-mail address and the vendor organisational entity. At the seventh step S207, the entity mapper 110 analyses the e-mail to identify process context data. In this case, for example, this may involve the recognition of the word “invoice” or a recognised invoice number in the text of the e-mail indicating that the e-mail relates to an invoice. At the eighth step S208, the relationship data (indicating a “vendor” type relationship) and the context data (indicating the e-mail relates to an invoice) is passed to the automation sequence initiator 111. The automation sequence initiator 111 determines in the case of e-mails received from vendors relating to invoice, the e-mail needs to be stored in an AP folder associated with the vendor organisational entity. The automation sequence initiator 111 then selects an automation sequence from the plurality of automation sequences 112 which at the ninth step S209 is initiated. In this case, there is no requirement for any further ERP object data, therefore, the process proceeds to the eleventh step S211, where the steps associated with the storing the received e-mail in a folder associated with the vendor organisational entity are performed.

A second illustrative example is now described. In this example, an e-mail is received from a customer querying an invoice that has been received. The automated sequence which is initiated relates to the automatic execution of workflow steps relating to handling this query, and in particular generating an e-mail response. Again, in this example, the e-mail address from which the e-mail is sent has not previously been mapped to the vendor.

With reference to FIGS. 1 and 2, at a first step S201, the message retrieval function 113 retrieves the e-mail from the e-mail client 106 via the first API 107. At the second step S202, the entity mapper 110 determines whether or not there is a pre-existing mapping between the sender of the e-mail and an organisational entity. In this case it is determined that such a mapping does not exist, therefore at a fourth step S204, the entity mapper 110 initiates the organisational entity identification process. This results in the customer organisational entity being identified, and at the fifth step S205, the relevant relationship data is retrieved from the relationship database 116 which indicates that the customer organisational entity is associated with a “customer” type relationship. At a sixth step S206, a mapping is made between the e-mail address and the customer organisational entity. At the seventh step S207, the entity mapper 110 analyses the e-mail to identify process context data. In this case, for example, this may involve the recognition of a phrase such as “invoice query” or similar and the recognition of an invoice number in the text of the e-mail identifying the invoice to which the query relates. At the eighth step S208, the relationship data (indicating a “customer” type relationship) and the context data (indicating the e-mail relates to an invoice query) is passed to the automation sequence initiator 111. The automation sequence initiator 111 determines in the case of e-mails received from customers relating to invoice queries, an AR invoice query process needs to be initiated.

The automation sequence initiator 111 then selects an automation sequence from the plurality of automation sequences 112 which at the ninth step S209 is initiated. In this example, the automation sequence may involve loading an invoice query workflow interface to display on the plurality of user devices 104 and to generate a draft of a proposed e-mail populated with the relevant data which a user of the user device 103 can review and then send to the customer organisational entity from whom the e-mail was received.

Accordingly, at the tenth step S210, the initiated automation sequence retrieves from the local ERP object data database ERP object data relating to the invoice identified at the seventh step S207 and any other relevant ERP object data necessary to populate an invoice query response e-mail. At the eleventh step S211 the initiated automation sequence runs by sending data to the user device 103 to present the invoice query workflow interface along with generating a draft e-mail responding to the invoice query and populated with the ERP object data.

In the example described above, the application server 102 is depicted as a separate entity connected to the e-mail client 106 via a first API 107. However, the skilled person will understand that, in certain embodiments, some or all of the functionality (e.g., the entity mapper 110, automation sequence initiator 111, plurality of automation sequences 112, message retrieval function 113, and so on) can be implemented as a “plug-in” deployed within the e-mail client 106. Such a plug-in can be installed and activated through the e-mail client's settings, extending its capability to include some or all of the functions provided by e-mail-driven automation sequence initiator engine. Such an integration may be advantageous in certain settings due to reduced reliance on external systems or API connections, resulting in improved efficiency and responsiveness of the e-mail management process.

Although embodiments of the invention have been described above in terms of e-mails, the skilled person will understand that in alternative implementations, any suitable equivalent type of electronic message can be used. For example, instant messaging platforms (such as WhatsApp or Slack), social media messaging systems (like Facebook Messenger or Twitter Direct Messages), collaborative communication tools (such as Microsoft Teams or Google Chat), SMS or MMS messages, and other forms of electronic communication that allow for the transmission of information between parties may be employed within the scope of the invention.

Embodiments of the invention can be integrated with suitable APIs with any suitable ERP systems provided by well-known ERP system providers. Examples of such providers include but are not limited to SAP, offering products such as SAP S/4HANA and SAP Business One; Oracle, with solutions like Oracle ERP Cloud and Oracle NetSuite; Microsoft, providing Microsoft Dynamics 365 Business Central and Microsoft Dynamics GP; Infor, known for Infor LN and Infor CloudSuite Industrial; Epicor, offering Epicor ERP and Epicor Prophet 21; IFS, with its IFS Applications suite; Sage, providing Sage X3 and Sage 300; Syspro, known for its SYSPRO ERP solution; Odoo, offering the open-source Odoo ERP platform; and Plex Systems, providing Plex Manufacturing Cloud. Embodiments of the invention can be integrated with suitable APIs with any suitable email clients provided by well-known email system providers. Examples of such providers include but are not limited to Microsoft, offering products like Outlook and Exchange; Google, with its widely used Gmail platform; Apple, providing the Apple Mail client for macOS and iOS devices; Mozilla, known for its Thunderbird email client; Yahoo, offering Yahoo Mail; ProtonMail, and Zoho Mail.

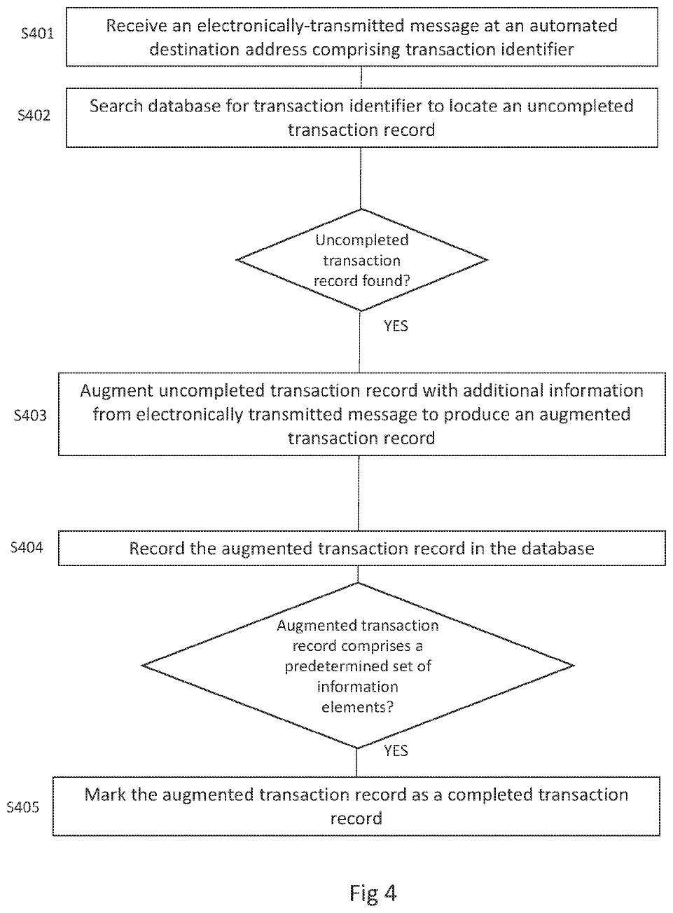

FIG. 4 provides a diagram depicting a process for executing inter-entity accounting transactions in accordance with certain examples.

At the first step S401, an automated facility for executing inter-entity accounting transactions receives an electronically-transmitted message at an automated destination address. This electronically-transmitted message includes a transaction identifier.

At the second step S402, the system conducts a search in a database of uncompleted transactions using the transaction identifier as a search criterion. The goal is to locate an uncompleted transaction record in the database.

At the third step S403, if an uncompleted transaction record is found in the database, the system proceeds to augment this uncompleted transaction record. The augmentation process comprises the incorporation of additional information, which is automatically extracted from the electronically transmitted message. This results in the creation of an augmented transaction record.

The fourth step S404 then comprises recording the augmented transaction record in the database. This ensures that the newly obtained information is properly stored and integrated into the existing database.

Finally, at the fifth step S405, the system checks if the augmented transaction record comprises a predetermined set of information elements. If this condition is met, the system marks the augmented transaction record as a completed transaction record.

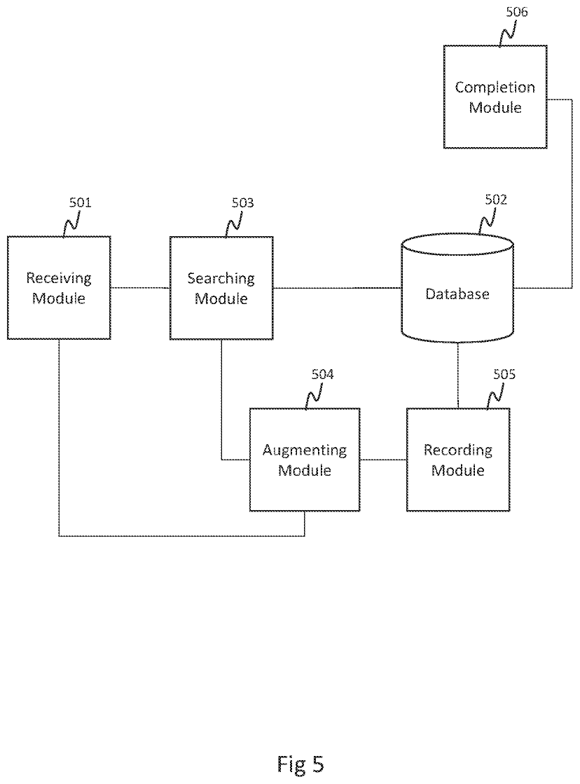

FIG. 5 provides a schematic diagram of a system for implementing an automated facility for executing inter-entity accounting transactions of a type described with reference to FIG. 4. The system comprises a receiving module 501, a database 502, a searching module 503, an augmenting module 504, a recording module 505, and a completion module 506. These components are interconnected to enable processing of inter-entity accounting transactions in accordance with the method shown in FIG. 4.

The receiving module 501 is configured to receive an electronically-transmitted message, typically an email, which has been received at an automated destination address. The receiving module 501 is configured to extract a transaction identifier from the electronically-transmitted message and communicate this to the searching module 503. The searching module 503 accesses the database 502 to locate an uncompleted transaction record corresponding to the transaction identifier. If found, the searching module 503 forwards the uncompleted transaction record to the augmenting module 504.

The augmenting module 504 retrieves the electronically-transmitted message from the receiving module 501 to extract additional information from the electronically-transmitted message and augment the uncompleted transaction record accordingly. Once the record is augmented, it is passed to the recording module 505. The recording module 505 updates the transaction record in the database 502 with the new information.

Lastly, the completion module 506 evaluates the augmented transaction record to determine if it contains a predetermined set of information elements. If the record meets the criteria, the completion module 506 marks it as completed in the database 502.

The additional information extracted from the electronically transmitted message may include any relevant information associated with accounting transactions. This could include, but is not limited to, any one or any combination of the following: the amount paid by a customer, the method of payment used, the date of the transaction, details of the goods or services for which the payment is being made (such as invoice number, purchase order number, or product codes), any notes or comments included by a customer, a bank account from which the payment was made, or any transaction fees or charges applied.

The predetermined set of information elements, which are used to determine if a transaction record can be marked as completed, may also vary according to the specific needs of the organisation. These could include, but are not limited to, any one or any combination of the following: the transaction identifier, a customer's name and contact details, an invoice number or purchase order number associated with the transaction, the total amount of a transaction, a payment method, a date of a transaction, confirmation that payment has been received in a company's bank account, or any additional details about the transaction as required by, for example, a company's accounting or finance departments.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A method of initiating an automation sequence, said method comprising:
at a computing system on which is running an automation-sequence initiator engine:
downloading and storing on data storage ERP object data from an ERP system associated with a first organisational entity;
retrieving from a messaging client an electronic message sent to the first organisational entity;
analysing the electronic message to identify entity-signifying metadata in the message;
querying the ERP object data in the data storage with the entity-signifying metadata to identify a further organisational entity, wherein, if a further organisational entity is identified,
identifying relationship data associated with the further organisational entity;
selecting an automation sequence based on the relationship data;
initiating the automation sequence, and
processing the electronic message in accordance with the initiated automation sequence.

2. A method according to claim 1, wherein if a further organisational entity is identified, the method further comprises:
generating a mapping between an address from which the electronic message was sent and the identified further organisational entity, and
storing the mapping to mapping storage.

3. A method according to claim 2, further comprising, on retrieving the electronic message, identifying an address from which the electronic message was sent;
querying the mapping storage to identify if a pre-existing mapping exists between the address from which the electronic message was sent and a pre-identified organisational entity, and if so:
identifying relationship data associated with the pre-identified organisational entity;
selecting an automation sequence based on the relationship data;
initiating the automation sequence, and
processing the electronic message in accordance with the initiated automation sequence.

4. A method according to claim 1, further comprising:
identifying process context data from the electronic message, and
selecting an automation sequence based on the relationship data and the process context data.

5. A method according to claim 4, wherein identifying the process context data from the electronic message comprises at least one of: processing the data content of the electronic message in accordance with a predetermined rule-based schema, and processing the data content of the electronic message using an AI-analysis function.

6. A method according to claim 4, further comprising:
adaptively processing the electronic message in accordance with the initiated automation sequence and the process context data.

7. A method according to claim 1, further comprising:
identifying one or more ERP objects from the ERP object data associated with the initiated automation sequence, and
adaptively processing the electronic message in accordance with the initiated automation sequence and the one or more ERP objects.

8. A method according to claim 1, wherein the entity-signifying metadata is a first type of entity-signifying metadata.

9. A method according to claim 8, wherein if on querying the data storage with the first type of entity-signifying metadata a further organisational entity is not identified, the method further comprises:
analysing the electronic message to identify a second type of entity-signifying metadata in the message, and
querying the data storage with the second type of entity-signifying metadata to identify the further organisational entity.

10. A method according to claim 9, wherein the first type of entity-signifying metadata comprises an originating domain from which the electronic message was sent, and the second type of entity-signifying metadata comprises message header data indicative of a contact address from whom the electronic message was sent.

11. A method according to claim 9, wherein if on querying the data storage with the first type of entity-signifying metadata a further organisational entity is not identified, the method further comprises:
analysing the content of the electronic message to identify further entity-signifying content data, and
querying the data storage with the further entity-signifying content data to identify the further organisational entity.

12. A method according to claim 11, wherein identifying the further entity-signifying content data from the electronic message comprises at least one of: processing the data content of the electronic message in accordance with a predetermined rule-based schema, and processing the data content of the electronic message using an AI-analysis function.

13. A method according to claim 1, wherein the initiated automation sequence implements one of a plurality of predefined business management processes.

14. A method according to claim 1, wherein processing the electronic message in accordance with the initiated automation sequence comprises presenting data relating to the automation sequence to a user via a user interface.

15. A method according to claim 1, wherein the electronic message is an e-mail message and the messaging client is an e-mail client.

16. A system for initiating automation sequences, said system comprising:
a computing system comprising data storage and on which is running an automation-sequence initiator engine;
a messaging client; and
a computer-implemented ERP system associated with a first organisational entity; wherein said computing system is communicatively connected to said ERP system and said messaging client, wherein said automation-sequence initiator engine is configured to:
download ERP object data from the ERP system and store the ERP object data on the data storage;
retrieve from the messaging client an electronic message sent to the first organisational entity;
analyse the electronic message to identify entity-signifying metadata in the message;
query the ERP object data in the data storage with the entity-signifying metadata to identify a further organisational entity, wherein, if a further organisational entity is identified, the automation-sequence initiator engine is further configured to:
identify relationship data associated with the further organisational entity;
select an automation sequence based on the relationship data;
initiate the automation sequence, and
process the electronic message in accordance with the initiated automation sequence.

17. An automation-sequence initiator engine for use in a system according to claim 16, said automation-sequence initiator engine configured to:
download and store on data storage ERP object data from an ERP system associated with a first organisational entity;
retrieve from a messaging client an electronic message sent to the first organisational entity;
analyse the electronic message to identify entity-signifying metadata in the message;
query the ERP object data in the data storage with the entity-signifying metadata to identify a further organisational entity, wherein, if a further organisational entity is identified, said automation-sequence initiator engine is further configured to:
identify relationship data associated with the further organisational entity;
select an automation sequence based on the relationship data;
initiate the automation sequence, and
process the electronic message in accordance with the initiated automation sequence.

18. A computer program which when run on a suitable computing device implements an automation-sequence initiator engine according to claim 17.

19. An automated facility for executing inter-entity accounting transactions, comprising:
receiving an electronically-transmitted message at an automated destination address, the electronically-transmitted message comprising a transaction identifier;
searching a database of uncompleted transactions for the transaction identifier to locate an uncompleted transaction record;
if the uncompleted transaction record is found, then augmenting the uncompleted transaction record with additional information extracted automatically from the electronically transmitted message to produce an augmented transaction record;
recording the augmented transaction record in the database; and
if the augmented transaction record comprises a predetermined set of information elements, marking the augmented transaction record as a completed transaction record.

20. A method according to claim 5, further comprising:
adaptively processing the electronic message in accordance with the initiated automation sequence and the process context data.
